(19) United States
(12) Patent Application Publication
(10) Pub. No.: US 2016/0006379 A1
(43) Pub. Date: Jan. 7, 2016

(54) HYBRID ELECTRIFICATION SYSTEM OF PUMP STATION AND OPTIMAL OPERATION METHOD THEREOF

(71) Applicant: ABB TECHNOLOGY LTD., Zurich (CH)

(72) Inventors: ZHAO WANG, BEIJING (CN); YAO CHEN, BEIJING (CN); GUOJU ZHANG, BEIJING (CN)

(21) Appl. No.: 14/771,332

(22) PCT Filed: Sep. 17, 2013
(86) PCT No.: PCT/CN2013/083623

§ 371 Date: Aug. 28, 2015

(51) Int. Cl. H02P 5/74

(52) U.S. Cl. CPC H02P 5/74

(57) ABSTRACT

The present invention discloses a hybrid electrification system of pump station and optimal operation method thereof. Said hybrid electrification system of pump station, comprises a central controller. It further comprises a shared Variable Frequency Drive (VFD) busbar and a common busbar, both of which being connected to said central controller. Said shared VFD busbar is shared by two or more said motor-pump chains and selectively drives one, two or more said motor-pump chains. Compared with the existing prior arts, the proposed solutions are much more intuitive and practical in the field of the pump station.

### FIELD OF THE INVENTION

This invention relates to the pump station technical field, and more particularly to a hybrid electrification system of pump station and optimal operation method thereof.

### BACKGROUND OF THE INVENTION

It is common understanding that for the pump loads, variable speed operation can achieve higher efficiency compared with the fixed speed operation. Therefore pump stations tend to install a Variable Frequency Drive (VFD) for each motor-pump chain to ensure high efficiency operation, as shown in FIG. 1A. However, this solution has several drawbacks. Firstly, the capital investment is high. Secondly, if the motor-pump chain is mostly working at rated speed, VFD solution might lower the efficiency due to its own power losses.

Another traditional electrification scheme of the pump station is shown in FIG. 1B. FIG. 1B shows the structure of a plurality of motor-pump chains which are jointly driven by one VFD and share the same operation point setting. It also has some disadvantages: Firstly, each motor-pump chain has low efficiency when the VFD utilized capacity is relatively low. Secondly, there are different ways for load distribution among different VFD-fed motor-pump chains to meet the same total output requirement. It is not always true to distribute the load evenly among individual chains in order to have optimal system efficiency.

To overcome above shortcomings, the person skilled in the art aims to solve two problems as follows.

1) How to design the electrification scheme of pump station with less capital investment while still maintaining the functions of VFD like soft start-up, speed regulation.

2) How to improve the operation efficiency of pump station by optimal load distribution considering the load demand of pump station, and speed regulation techniques and efficiency curves of different motor-pump chains.

### SUMMARY OF THE INVENTION

The object of the present invention is achieved by a hybrid electrification system and the corresponding control method of pump station, in order to reduce the capital cost and operation cost, and to optimize the operation efficiency of whole pump station.

According to one aspect of the invention, said hybrid electrification system of pump station, comprises a central controller. It further comprises a shared Variable Frequency Drive (VFD) busbar and a common busbar, both of which being connected to said central controller. Said shared VFD busbar is shared by two or more said motor-pump chains and selectively drives one, two or more said motor-pump chains.

According to a preferred embodiment of the present invention, said common busbar is supplied by a transformer with an On-Load Tap Changer.

According to a preferred embodiment of the present invention, each of said motor-pump chain connects to a Single Pole Three Throw switch, which switches said motor-pump chain among common busbar connecting, shared VFD busbar connecting, and disconnecting.

According to a preferred embodiment of the present invention, said system further comprises a motor-pump chain supplied by an un-shared VFD.

According to a preferred embodiment of the present invention, said un-shared VFD is connected to said common busbar directly.

According to a preferred embodiment of the present invention, said un-shared VFD is driven by a separate transformer without connection to said common busbar.

According to another aspect of the invention, a method to optimize the operation efficiency of the pump station, comprises the following steps: preprocessing the initial data input by user; forecasting the liquid load or gets the predefined liquid load demand of next time interval; calculating the control commands of the pump station; and executing the results by controlling a VFD and/or an On-Load Tap Changer and/or a Single Pole Three Throw switch.

According to a preferred embodiment of the present invention, said preprocessing step comprises the following steps: collecting parameters of pumps with shared VFD busbar; collecting parameters of pumps with un-shared VFD busbar; collecting parameters of pumps with the common busbar supplied by the On-Load Tap Changer; identifying pipe resistance parameters; defining the numbers of motor-pump chain directly driven by the VFD busbars to achieve the partial optimization requirement.

According to a preferred embodiment of the present invention, said forecasting step further comprises the following steps: calculating the parameters of the pump station with liquid pipe resistance curve; updating the pump list by calculating the parameters of motor-pump chains with or without the VFD for maximum efficiency.

According to a preferred embodiment of the present invention, said calculating step follows three options in sequence to meet the load demand: only the VFD adjustment can meet load demand; the VFD and the On-Load Tap Changer adjustment can meet load demand; recalculating the control demands for the whole pump station, including the VFD, the On-Load Tap Changer and the Single Pole Three Throw switch.

According to a preferred embodiment of the present invention, said recalculating step comprising the following steps: initializing the pump list; calculating the remaining liquid flow demand; calculating the pump list parameter to achieve maximum efficiency; selecting the motor-pump chain with the highest efficiency with or without VFD; or doing partial optimization for finding the most efficient list to provide the remaining liquid flow.

According to a preferred embodiment of the present invention, said executing step including: adjusting the frequency of the motor-pump chain which connects to shared and/or the un-shared VFD busbar to system frequency; adjusting the voltage of common busbar for the On-Load Tap Changer operation according to the voltage requirement.

Compared with the existing prior arts, the solution of the present invention saves the number and size of VFDs and soft-starters, while still maintaining motor soft-start and efficiency improvement functions. Another benefit of the present invention is that it can optimize the real-time operation efficiency of pump station by coordinating the power supply scheme, load distribution way and transformer OLTC and VFD settings for individual motor-pump chain.

### BRIEF DESCRIPTION OF THE DRAWINGS

The subject matter of the invention will be explained in more details in the following description with reference to preferred exemplary embodiments which are illustrated in the drawings, in which:

FIG. 1 shows an electrification scheme of the conventional pump station; in which FIG. 1A illustrates the structure of respectively installing VFD for each motor-pump chain, and FIG. 1B illustrates the structure of a plurality of motor-pump chains jointly driven by one VFD;

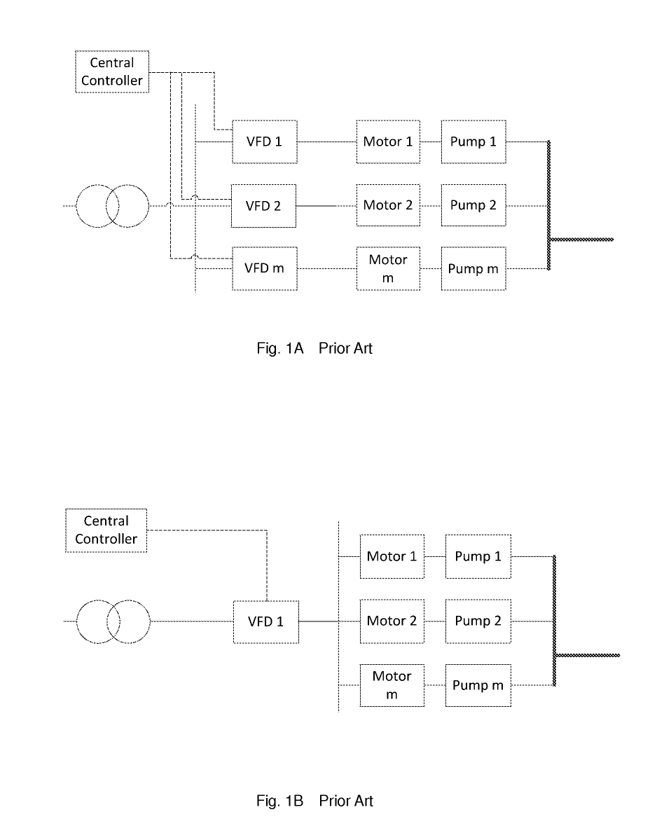

FIG. 2 shows a hybrid electrification scheme of the hybrid pump station according to an embodiment of the present invention;

FIG. 3 shows the structure of the present invention; in which FIG. 3A illustrates the hybrid electrification scheme I of the pump station, and FIG. 3B illustrates the hybrid electrification scheme II of the pump station;

FIG. 4 is the main flow-chart showing operation efficiency optimization for pump station with hybrid electrification scheme;

FIG. 5 illustrates a flow chart of parameters preprocessing procedures according to an embodiment of the present invention;

FIG. 6 illustrates a flow chart of control command determination according to an embodiment of the present invention;

FIG. 7 illustrates a flow chart of overall optimization procedures according to an embodiment of the present invention;

FIG. 8 illustrates a flow chart of control command execution according to an embodiment of the present invention.

### DETAILED DESCRIPTION OF PREFERRED EMBODIMENTS

Exemplary embodiments of the present invention are described in conjunction with the accompanying drawings hereinafter. For the sake of clarity and conciseness, not all the features of actual implementations are described in the specification.

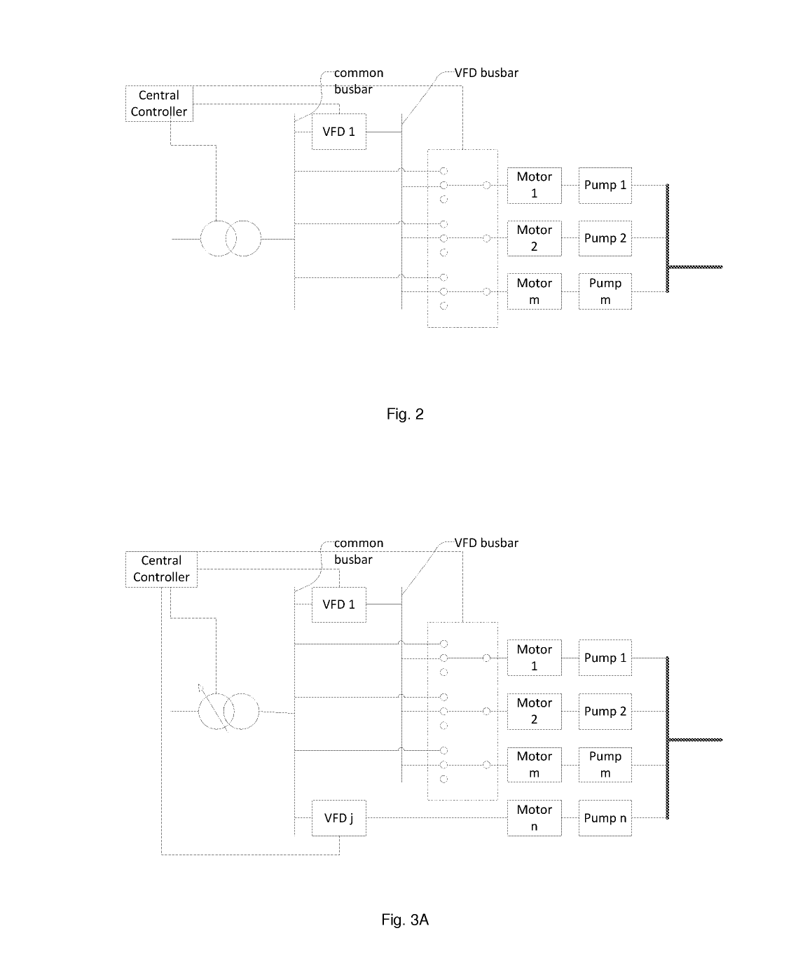

According to the first preferred embodiment, the hybrid electrification system of pump station of the present invention is shown in FIG. 2, which consists of a VFD busbar supplied by a shared VFD (e.g. VFD1 in FIG. 2).

As shown in FIG. 2, two or more motor-pump chains can be connected to a common busbar or the VFD busbar through Single Pole Three Throw (SPTT) switches. That means, the motor-pump chains can only have one out of three statuses at one time: common busbar connecting, which means connecting to the common busbar; shared VFD busbar connecting, which means connecting to the VFD busbar; or disconnecting from both the common busbar and the VFD busbar.

In order to optimize the operation efficiency, the status information of VFDs and SPTT switches are all transmitted to a central controller. Besides these, the central controller also gets access to the real-time liquid load data and the forecasted liquid load. With all these data, the controller performs the optimization calculation of the whole pump station. After that, it will send out the control command to controllable devices, e.g. VFDs, for wide-range motor speed regulation.

By using SPTT switches, the start-up process of the motor-pump chains can be optimized. As shown in FIG. 2, the SPTT can switch a motor-pump chain to the VFD busbar for soft start. After completing the start-up process, the SPTT can switch this motor-pump chain to the common busbar and so that to save the soft-start devices. After starting all the required motor-pump chains through the VFD, these motor-pump chains can be then switched back to the VFD busbar and driven by the shared VFD, i.e. VFD1, for motor speed regulation and operation efficiency optimization.

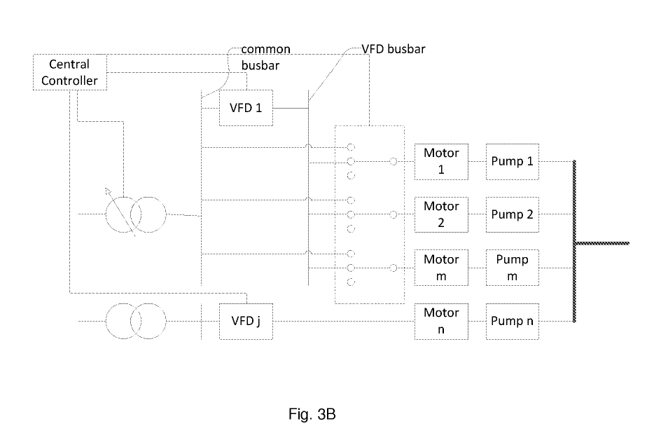

According to the second preferred embodiment, the hybrid electrification scheme I of pump station is shown in Figure 3A, which consists of main two busbars: 1) common busbar supplied by transformer with OLTC; 2) VFD busbar supplied by shared VFD (e.g. VFD1 in FIG. 3A).

As shown in FIG. 3A, two or more motor-pump chains can be connected to the common busbar or VFD busbar through SPTT (Single Pole Three Throw) switches. That means, the motor-pump chains can only have one out of three statuses at one time: connecting to common busbar, connecting to VFD busbar, or disconnecting from both common busbar and VFD busbar.

In order to supply at least two motor-pump chains, the capacity requirement on the shared VFD is relatively high. There are also motor-pump chains supplied by individual VFDs, e.g. VFDj connected directly to the common busbar shown in FIG. 3A, in order to achieve even smooth operation. These additional VFDs will usually have smaller capacity compared with the shared VFD.

In order to optimize the operation efficiency, the status information of OLTC, VFDs and SPTT switches are all transmitted to a central controller. Besides these, the central controller also gets access to the real-time liquid load data and the forecasted liquid load. With all these data, the controller performs the optimization calculation of the whole pump station. After that, it will send out the control command to controllable devices, e.g. VFDs, for wide-range motor speed regulation; or it will control the devices directly, e.g. OLTC, for small-range motor speed regulation through stator voltage adjustment.

By using SPTT switches, the start-up process of motor-pump chains can be optimized. As shown in FIG. 3A, the SPTT can switch a motor-pump chain to the VFD busbar for soft start. After completing the start-up process, the SPTT can switch this motor-pump chain to the common busbar and so that to save the soft-start devices. After starting all the required motor-pump chains through the VFD, these motor-pump chains can be then switched back to the VFD busbar and driven by the shared VFD, i.e. VFD1, for motor speed regulation and operation efficiency optimization.

According to the third preferred embodiment, another possible electrification scheme is shown in FIG. 3B, wherein the individual VFD-motor-pump chain can be fed by a separate transformer without OLTC. When a small change occurs to the liquid load, these individual VFD-motor-pump chains will be controlled to balance the small load change. That means it does not need to operate the OLTC, which will alleviate the impact on OLTC. By doing this, the control method can also be simplified because the OLTC adjustment will not affect the line side voltage of the individual VFD-motor-pump chains.

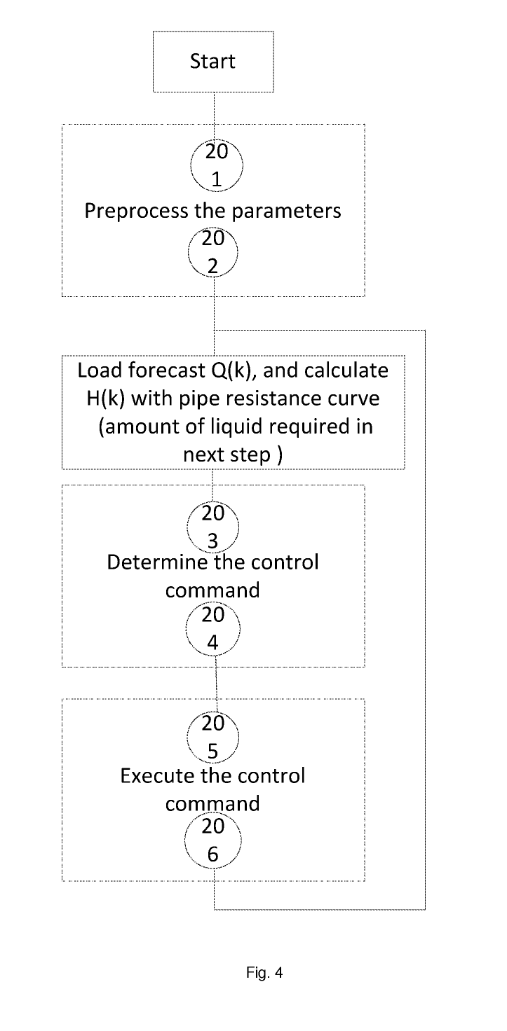

According to another preferred embodiment, the central controller performs the optimization calculation in real-time. The flowchart is shown in FIG. 4. Whenever the optimization result changes, the central controller will update the control commands for OLTCs, VFDs and/or SPTT switches respectively.

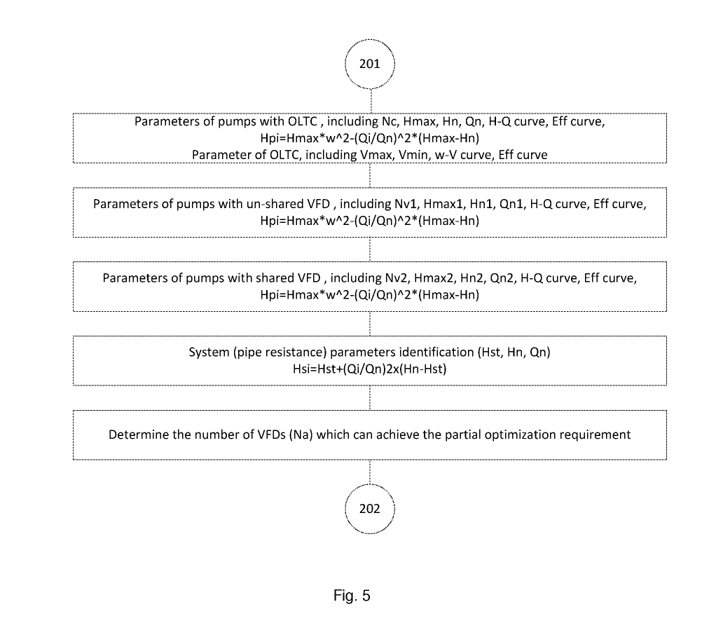

Step 201: the first step of the flowchart is to preprocess the initial data input by user, as shown in FIG. 5, where totally four groups of data will be collected as follows:

1) The number of OLTC Nc and the parameters of supplied motor-pump chains, including firstly the max head Hmax_i, rated head Hn_i, rated flow Qn_i, efficiency curve, and H-Q curve of pump i (the H-Q curve can be calculated as Hp_i=Hmax_i* ̂ 2-(Q_i/Qn-i)̂ 2*(Hmax_i-Hn_i)), where Q_i or Hp_i is the objective, and can be calculated by =(Hp_i/Hn_i)* ₙ or =(Q_i/Qn_i)̂2* ₙ; and secondly the voltage regulation range of OLTC (Vmin, Vmax); thirdly the speed-voltage curve and efficiency curve of motors.

2) The number of shared VFDs Nv1 and the parameters of supplied motor-pump chains. The required information of pumps are the same as above; plus the efficiency curve of motors and VFDs.

3) The number of individual VFDs Nv2 and the parameters of supplied motor-pump chains. The required information of pumps, motors and VFDs are the same as above.

4) The parameters to identify pipe resistance curve, including static head Hst, rated head Hn and rated flow Qn (the pipe resistance curve can be calculated as

Hsi=Hst+(Qi/Qn)2×(Hn-Hst))

After the preprocessing, all information except real-time data will be ready for calculation. Also, in this step, user needs to define the numbers of motor-pump chains Nva which can be directly driven by the VFDs according to their capacity. The number Na can be determined according to the efficiency improvement requirement, e.g. Nva=3 can make sure the efficiency of motor-pump chains can be improved by at least 3 VFDs. The efficiency improvement depends on the efficiency of motor-pump chains and VFDs.

All parameters are stored in a table which also stores the real-time data and calculation results. An example is shown in Table 1, where

1) Type: shows the type of motor-pump chain, e.g. ‘C’ means the motor-pump chain connects to common busbar, ‘V2’ means the motor-pump chain connects to the VFD busbar, and ‘V1’ means the motor-pump chain connects to un-shared VFD.

2) Status: shows the operation status of motor-pump chain, e.g. on or off.

3) Voltage: shows the OLTC voltage adjustment result which calculated by optimization.

4) Frequency: shows the VFD frequency adjustment result which calculated by optimization.

5) Q: means the liquid flow provided by pump.

6) Eff: means the Efficiency of the whole motor-pump chain with or without VFD.

7) Control: means the control command from central controller, e.g. start or stop.

TABLE 1
Pump list

| | Type | Status | Voltage | Frequency | Q | Eff | Control |
|---|---|---|---|---|---|---|---|
| Pump with OLTC 1 | C | On | Vn + Va | 50 | 500 | 0.97 | Start |
| . . . | C | . . . | | | . . . | . . . | . . . |
| Pump with OLTC Nc | C | On | Vn + Va | 50 | 500 | 0.97 | Start |
| Pump with shared VFD 1 | V2 | Off | Vn + Va | 50 | 500 | 0.96 | Start |
| . . . | V2 | . . . | | | . . . | . . . | . . . |
| Pump with shared VFD Nv2 | V2 | On | Vn + Va | 40 | 500 | 0.96 | Start |
| Pump with unshared VFD 1 | V1 | On | Vn + Va | 30 | 200 | 0.95 | Stop |
| . . . | V1 | . . . | | | . . . | . . . | . . . |
| Pump with unshared VFD Nv1 | V1 | off | Vn + Va | 35 | 200 | 0.95 | Start |

Step 202: the second step, the central controller forecasts the liquid load or gets the predefined liquid load demand Q(k) or H(k) of next time interval tk. With these data, the central controller calculates the H(k) or Q(k) of pump station with liquid pipe resistance curve, and update the pump list by calculating the parameters of motor-pump chains with or without VFDs for maximum efficiency.

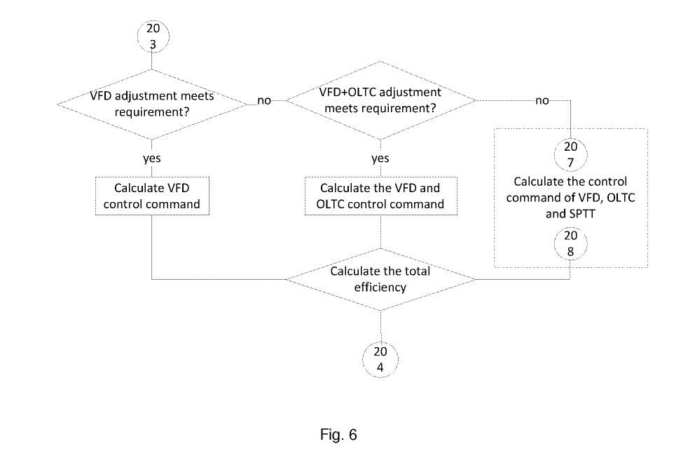

Step 203: the third step, the central controller calculates the control commands of pump station. In this invention, we assume that liquid flow demand Q(k) can be obtained for control optimization (with H(k) available the algorithm can also work). Based on the liquid flow demand and the status of all motor-pump chains, the control strategy will lead to three possible operation solutions as shown in FIG. 6.

When to increase or decrease the liquid flow, the central controller evaluates the following three options in sequence:

1) meet the liquid flow demand by VFD control;

2) meet the liquid flow demand by VFD control together with OLTC voltage adjustment;

3) recalculate the control commands for the whole pump station.

If option 1) works, the central controller calculates the frequency required. Else, if the option 2) works, the central controller calculates the frequency and voltage required. In both of these options, no additional pumps will be started or stop, the controller will try to meet the load deviation by adjusting the motor-pump chains already on-line.

Otherwise, the central controller will conduct the control command calculation for whole pump station, which means not only VFD and OLTC, the operation status of SPTT also needs to be changed in order to meet the load demand, pump start/stop will be necessary.

The objective of prioritizing the operation sequence of VFD, OTLC and SPTT, is to limit the operation time of OLTC and avoid frequent start/stop of the pumps, which can help to minimize the voltage/current impact on the primary equipment and further extend their life cycle.

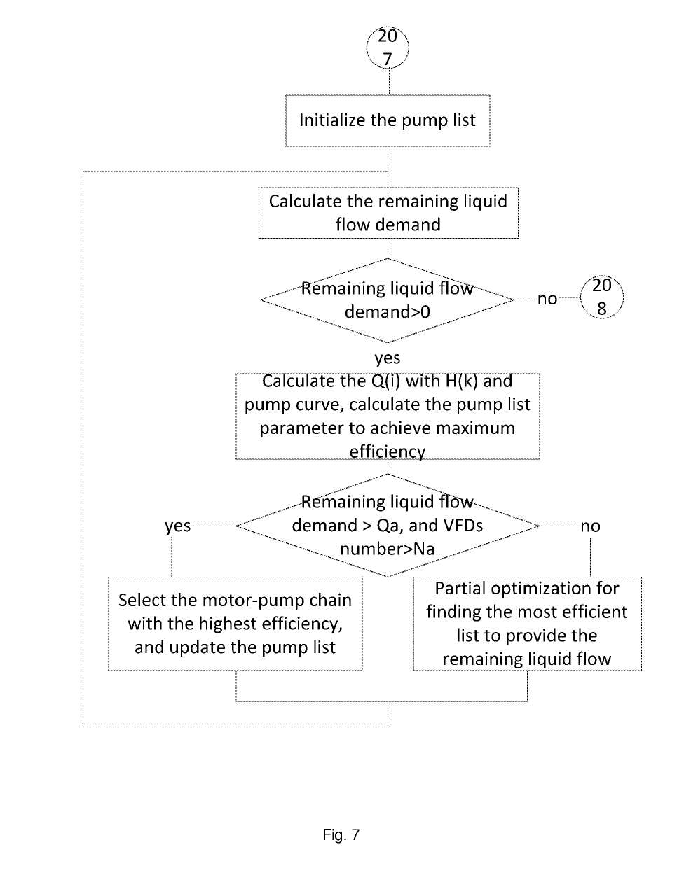

The flowchart for calculating the whole pump station control commands is shown in FIG. 7. Firstly, the central controller firstly initializes the pump list. Then, to finally meet the liquid flow demand, the central controller repeats to switch on the SPTTs for the motor-pump chains with highest efficiency or to do the partial optimization within Nva VFDs.

The criteria for doing the partial optimization include two aspects:

1) the remaining liquid flow demand is no higher than Qa which is calculated by Qa=min(Σⱼ₌₁^{Nva}Qv(j)), where Qv is the liquid flow that can be provided by the remaining motor-pump chain with highest efficiency;

2) the number of remaining VFD-fed motor-pump chains is no higher than Nva which is defined in Step 201.

As introduced above, if neither of the criteria of partial optimization are satisfied, the central controller will switch on the SPTT for the motor-pump chain with maximum efficiency.

However, if only the second criterion for partial optimization is not satisfied, the central controller will switch on the SPTT of the motor-pump chain which can achieve highest efficiency without VFD, and then get the pump list updated.

If the both of the criteria of partial optimization is satisfied, the central control will determine the SPTT commands and calculate the optimized load demand distribution list by comparing the efficiency of all permutation and combination of Nva sets of motor-pump chains with VFD and Nca sets of motor-pump chains without VFD. Nca is calculated by Nca=ceil(Qr/Qc)Nca=ceil(Qr/Qc), where Qr is the remaining liquid flow demand, and Qc is the liquid flow which provided by motor-pump chain in highest efficiency. The combination with the highest efficiency will be selected. Also, the central controller will calculate the frequency required for all VFDs and the voltage of common busbar for OLTC operation.

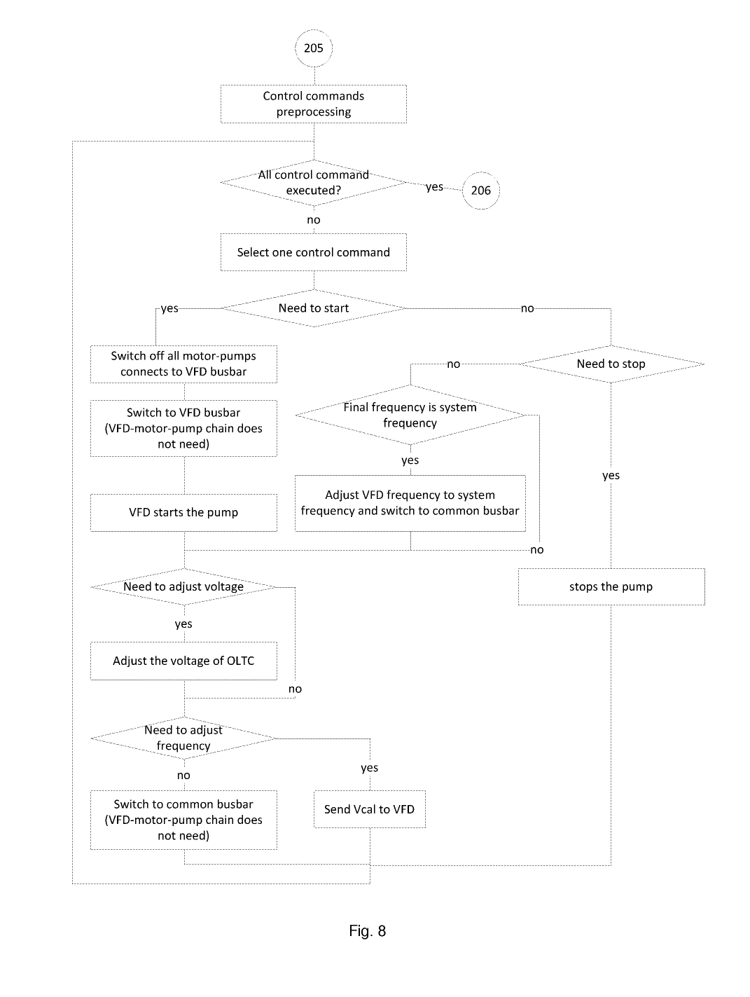

Step 204: the fourth step, after the control commands calculation, the central controller will execute the results by controlling OLTC and/or SPTT directly or sending the control command to all VFDs, as shown in FIG. 8, where the control actions includes the start and stop of pump, SPTT switch operation, OLTC adjustment, and VFD frequency regulation.

Firstly, the central controller preprocesses the control commands by sorting the control commands to save the operations of VFDs. The sequence of control commands will be: 1) stop the motor-pump chain, 2) adjust the frequency of motor-pump chain which connects to VFD busbar to system frequency, 3) start the motor-pump chain which will connects to VFD busbar and adjust the frequency to system frequency, 4) start the motor-pump chain which will connect to VFD busbar and adjust the frequency which not equals to system frequency, 5) start the individual VFD-motor-pump chain or adjust its frequency.

To start the pump, the central controller switches the motor-pump to VFD busbar supplied by shared VFD. Then, the central controller asks shared VFD to start the motor-pump. The central controller adjusts the OLTC according to voltage requirement. If the frequency of motor-pump equals to system frequency, the central controller switches the motor-pump chain to common busbar, or it sends the frequency requirement to VFDs.

To stop the pump, the central controller switches the motor-pump to VFD busbar for shared VFD. Then, the central controller asks shared VFD to stop the motor-pump.

If the pump does not need start or stop, the central controller adjusts the OLTC according to voltage requirement. If the frequency of motor-pump equals to system frequency, the central controller switches the motor-pump chain to common busbar, or it sends the frequency requirement to VFDs.

The central controller repeats the Step 202, Step 203 and Step 204 in real-time.

Advantages of the system and method according to this invention:

This invention proposes a hybrid electrification system and the corresponding control method of pump station, in order to reduce the capital cost and operation cost, and to optimize the operation efficiency of whole pump station.

Taking into account the regulation capability of VFDs and OLTC of transformer, this invention uses the VFD busbar and common busbar to drive the multiple motor-pump chains. By sharing VFD among two or more motor-pump chains, several benefits can be achieved like saving VFD capacity, eliminating soft-star devices, and improving the efficiency comparing to those motor-pump chains without VFDs.

Taking into account the OLTC voltage adjustment capability, the invention uses transformer with OTLC to supply the common busbar to adjust the voltage and thus to regulate motor speed to some extent. This can help to save the number of VFD required and improves the efficiency comparing to those motor-pump chains without OLTC.

With the system described above, this invention further proposes the optimized operation and control solution which considers the utilization priority of VFD and OLTC. Also, the invention presents the method to start or stop the motor-pump chains, the method to increase or decrease the liquid flow, and the database format to store the parameters and data.

Though the present invention has been described on the basis of some preferred embodiments, those skilled in the art should appreciate that those embodiments should by no means limit the scope of the present invention. Without departing from the spirit and concept of the present invention, any variations and modifications to the embodiments should be within the apprehension of those with ordinary knowledge and skills in the art, and therefore fall in the scope of the present invention which is defined by the accompanied claims.

1. A hybrid electrification system of pump station, comprising:
a central controller;
a shared Variable Frequency Drive (VFD) busbar; and
a common busbar, wherein the shared VFD busbar and the common busbar connect to said central controller; and
wherein said shared VFD busbar is shared by two or more motor-pump chains and selectively drives one or more said motor-pump chains.

2. The system according to claim 1, wherein said common busbar is supplied by a transformer with an On-Load Tap Changer.

3. The system according to claim 1, wherein each of said motor-pump chain connects to a Single Pole Three Throw switch, which switches said motor-pump chain among the common busbar the shared VFD busbar.

4. The system according to claim 3, further comprising:
a motor-pump chain supplied by an un-shared VFD.

5. The system according to claim 4, wherein said un-shared VFD connects to said common busbar directly.

6. The system according to claim 4, wherein said un-shared VFD is driven by a separate transformer without connection to said common busbar.

7. A method to optimize an operation efficiency of a pump station, comprising:
preprocessing initial data input by user;
forecasting a liquid load or getting a predefined liquid load demand of next time interval;
wherein forecasting includes:
calculating parameters of a pump station with liquid pipe resistance curve; and
updating a pump list by calculating parameters of motor-pump chains with or without a shared VFD for maximum efficiency;
calculating -fee-control commands of the pump station; and
executing the control commands by controlling at least one of the shared VFD, an On-Load Tap Changer or a Single Pole Three Throw switch.

8. The method according to claim 7, wherein said preprocessing includes:
collecting parameters of pumps with a shared VFD busbar;
collecting parameters of pumps with a un-shared VFD busbar;
collecting parameters of pumps with a common busbar supplied by the On-Load Tap Changer;
identifying pipe resistance parameters; and
defining a number of motor-pump chain directly driven by the shared and un-shared VFD busbars to achieve a partial optimization requirement.

9. (canceled)

10. The method according to claim 7, wherein said calculating includes three options in sequence to meet the load demand:
1) adjusting the shared VFD busbar which meets load demand;
2) adjusting the shared VFD busbar and the On-Load Tap Changer which meets load demand; and
3) recalculating the control commands for the pump station, including the shared VFD busbar, the On-Load Tap Changer and the Single Pole Three Throw switch.

11. The method according to claim 10, wherein said recalculating includes:
initializing the pump list;
calculating a remaining liquid flow demand; and
calculating a pump list parameter to achieve maximum efficiency.

12. The method according to claim 7, wherein said executing includes:
adjusting a frequency of the motor-pump chain which connects to a system frequency at least one of the shared VFD busbar or the un-shared VFD busbar; and
adjusting a voltage of common busbar for the On-Load Tap Changer operation according to the voltage requirement.

13. The method according to claim 11, further including:
selecting the motor-pump chain with a highest efficiency with or without a shared VFD busbar.

14. The method according to claim 11, further including:
doing partial optimization for finding a most efficient list to provide the remaining liquid flow demand.

15. The system according to claim 3, wherein the Single Pole Three Throw switch includes at least one of a connect or a disconnect of the common busbar.

16. The system according to claim 3, wherein the Single Pole Three Throw switch includes at least one of a connect or a disconnect of the shared VFD busbar.
